(19) United States
(12) Patent Application Publication
(10) Pub. No.: US 2026/0003976 A1
(43) Pub. Date: Jan. 1, 2026

(54) SYSTEM AND METHOD FOR RECURSIVE INSPECTION OF WORKLOADS FROM CONFIGURATION CODE TO PRODUCTION ENVIRONMENTS

(71) Applicant: Wiz, Inc., New York, NY (US)

(72) Inventors: Raaz HERZBERG, Tel Aviv (IL); Yaniv Joseph OLIVER, Tel Aviv (IL); Osher HAZAN, Mazkeret Batia (IL); Niv Roit BEN DAVID, Tel Aviv (IL); Ami LUTTWAK, Binyamina (IL); Roy REZNIK, Tel Aviv (IL)

(73) Assignee: Wiz, Inc., New York, NY (US)

(21) Appl. No.: 19/317,908

(22) Filed: Sep. 3, 2025

Related U.S. Application Data
(63) Continuation of application No. 18/055,234, filed on Nov. 14, 2022.
(60) Provisional application No. 63/264,550, filed on Nov. 24, 2021.
(60) Provisional application No. 63/283,376, filed on Nov. 26, 2021.
(60) Provisional application No. 63/283,378, filed on Nov. 26, 2021.
(60) Provisional application No. 63/283,379, filed on Nov. 26, 2021.

(51) Int. Cl. G06F 21/57; G06F 9/455; G06F 16/901; G06F 21/53; G06F 21/55; H04L 9/40

(52) U.S. Cl. CPC G06F 21/577; G06F 9/45558; G06F 16/9024; G06F 21/53; G06F 21/554; H04L 63/1416; H04L 63/1433; H04L 63/1441; H04L 63/20; G06F 2009/4557; G06F 2009/45583; G06F 2009/45587; G06F 2009/45595; G06F 2221/034

(57) ABSTRACT

A system and method for inspecting multiple instances across cloud computing environments for a cybersecurity issue is presented. The system is configured to: detect a code object in a configuration code file, the code object utilized to deploy a virtual instance in a cloud computing environment; generate in a security graph a code object node representing the code object; generate in the security graph a resource node representing a virtual instance deployed in a first cloud computing environment based on the code object, wherein the resource node is connected to the code object node; detect a cybersecurity issue on the virtual instance; and generate an instruction to inspect a second virtual instance deployed in a second cloud computing environment based on the code object, the second virtual instance represented by a second resource node connected to the code object node.

### CROSS-REFERENCE TO RELATED APPLICATIONS

This application is a continuation of U.S. Non-Provisional application Ser. No. 18/055,234, filed Nov. 14, 2022, which claims the benefit of U.S. Provisional Application No. 63/264,550 filed on Nov. 24, 2021. This application also claims the benefit of U.S. Provisional Application No. 63/283,376 filed on Nov. 26, 2021, U.S. Provisional Application No. 63/283,378 filed on Nov. 26, 2021, and U.S. Provisional Application No. 63/283,379 filed on Nov. 26, 2021, the contents of which are hereby incorporated by reference.

All of the applications referenced above are hereby incorporated by reference.

### TECHNICAL FIELD

The present disclosure relates generally to cybersecurity and, in particular, to improved scanning of virtual instances utilizing infrastructure as code.

### BACKGROUND

As users migrate data storage, processing, and management tasks to decentralized, off-location devices, platforms, and services, the limitations of such devices, platforms, and services, also referred to as cloud environments, platforms, and the like, may impact a user's data operations. Specifically, vulnerabilities within cloud-deployed resources and processes may present unique challenges requiring remediation. Due to the scale and structure of cloud systems, detection of workload vulnerabilities, which detection may be readily-provided in non-cloud deployments, may require numerous, complex tools and operations.

Current solutions to cloud workload vulnerability scanning challenges require the deployment of specialized tools, including scanning agents directed to maintenance of virtual machines (VMs), where operation and maintenance of such tools may be costly, time-consuming, or both. Agent-dependent processes fail to provide for scanning of containers, such as containers managed using Kubernetes®, and other, like, container-management platforms, and may fail to provide for coverage of serverless applications. Where such agent-implementation processes fail to provide for full cloud workload vulnerability scanning, additional methods, such as snapshot-based scanning, may supplement implemented solutions.

Snapshot-based scanning, wherein static “snapshots” of processes, services, data, and the like, are analyzed in an environment separate from the source environment, provides for agentless scanning. Snapshot-based scanning is applied in various fields, including computer forensics, to provide for analysis of services, processes, data, and the like, in locations or environments other than those from which the snapshots are collected, as well as retrospective analysis. However, the applicability of snapshot-based scanning is limited in multi-tenant systems, such as shared cloud platforms, as cloud tenants may desire high levels of data protection during snapshot generation, transfer, and analysis. Further, snapshot-based scanning methods, as well as hybrid methods including both agent-implemented and snapshot-based methods, may be inapplicable to certain cloud system structures and environments, which may include various objects, processes, and the like, which such methods may not be configured to process, as such processing may require, as examples, separate analysis of container repositories, VM snapshots, and application programming interfaces (API) for serverless applications, where existing solutions fail to provide such integrated functionality.

Further complicating matters is deployment of cloud environments utilizing infrastructure as code (IaC) systems. While aimed at decreasing human error when deploying cloud environments, there is often a drift from the original configuration code to the current state of the production environment. A complication may arise due, for example, to different teams working on the development environment (configuration code) and the production environment (deployed instances). Current tools such as Checkov® and Accurics® allow to scan for misconfigurations and policy violations, but are limited to scanning only configuration code. CI/CD (continuous integration/continuous deployment) and drifting configurations mean that scanning the configuration code is not always enough to get a precise understanding of where threats and vulnerabilities currently exist, since in practice this is a moving target.

It is apparent that it would be advantageous to provide a solution which can scan for vulnerabilities in an improved and efficient manner, and provide a solution which encompasses a technology stack from code, through staging, to production.

Furthermore, it would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for inspecting multiple instances across cloud computing environments for a cybersecurity issue. The method comprises: detecting a code object in a configuration code file, the code object utilized to deploy a virtual instance in a cloud computing environment; generating in a security graph a code object node representing the code object; generating in the security graph a resource node representing a virtual instance deployed in a first cloud computing environment based on the code object, wherein the resource node is connected to the code object node; detecting a cybersecurity issue on the virtual instance; and generating an instruction to inspect a second virtual instance deployed in a second cloud computing environment based on the code object, the second virtual instance represented by a second resource node connected to the code object node.

Certain embodiments disclosed herein also include a non-transitory computer readable medium having stored thereon causing a processing circuitry to execute a process, the process comprising: detecting a code object in a configuration code file, the code object utilized to deploy a virtual instance in a cloud computing environment; generating in a security graph a code object node representing the code object; generating in the security graph a resource node representing a virtual instance deployed in a first cloud computing environment based on the code object, wherein the resource node is connected to the code object node; detecting a cybersecurity issue on the virtual instance; and generating an instruction to inspect a second virtual instance deployed in a second cloud computing environment based on the code object, the second virtual instance represented by a second resource node connected to the code object node.

Certain embodiments disclosed herein also include a system for inspecting multiple instances across cloud computing environments for a cybersecurity issue. The system comprises: a processing circuitry; and a memory, the memory containing instructions that, when executed by the processing circuitry, configure the system to: detect a code object in a configuration code file, the code object utilized to deploy a virtual instance in a cloud computing environment; generate in a security graph a code object node representing the code object; generate in the security graph a resource node representing a virtual instance deployed in a first cloud computing environment based on the code object, wherein the resource node is connected to the code object node; detect a cybersecurity issue on the virtual instance; and generate an instruction to inspect a second virtual instance deployed in a second cloud computing environment based on the code object, the second virtual instance represented by a second resource node connected to the code object node.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include detecting a code object in a configuration code file, the code object utilized to deploy a virtual instance in a first cloud computing environment. The method may also include generating in a security database a code object node representing the code object. The method may furthermore include generating in the security graph a first resource node representing the virtual instance. The method may in addition include accessing a mapping between the code object and the virtual instance. The method may moreover include generating in the security graph a connection between the code object node and the first resource node based on the mapping. The method may also include detecting a cybersecurity issue on the virtual instance. The method may furthermore include generating an instruction to inspect a second virtual instance deployed based on the code object in a second cloud computing environment, where the second virtual instance represented by a second resource node connected to the code object node. Other embodiments of this aspect include corresponding computer systems, apparatus, and computer programs recorded on one or more computer storage devices, each configured to perform the actions of the methods.

Implementations may include one or more of the following features. The method may include: detecting a value of a data field in the code object; and generating the connection between the code object node and the first resource node in response to detecting the value in a corresponding data field of the first resource node. The method may include: generating a connection between the code object node and the second resource node in response to detecting the value in a corresponding data field of the second resource node. The method may include: generating an instruction to inspect the code object in response to detecting the cybersecurity issue on the virtual instance. The method may include: generating a cybersecurity issue node in the security database to represent the detected cybersecurity issue. The method where the first cloud computing environment is a production environment, and the second cloud computing environment is any one of: a staging environment, a testing environment, and a development environment. The method where the security database further includes a representation of the first cloud computing environment and a representation of a second cloud computing environment. The method may include: parsing the configuration code file to detect the code object. The method where the code object includes a data field, and the data field is any one of: a resource type identifier, an application identifier, a virtual private cloud identifier, and an instance type identifier. Implementations of the described techniques may include hardware, a method or process, or a computer tangible medium.

In one general aspect, a non-transitory computer-readable medium may include one or more instructions that, when executed by one or more processing circuitries of a device, cause the device to: detect a code object in a configuration code file, the code object utilized to deploy a virtual instance in a first cloud computing environment; generate in a security database a code object node representing the code object; generate in the security graph a first resource node representing the virtual instance; access a mapping between the code object and the virtual instance; generate in the security graph a connection between the code object node and the first resource node based on the mapping; detect a cybersecurity issue on the virtual instance; and generate an instruction to inspect a second virtual instance deployed based on the code object in a second cloud computing environment, where the second virtual instance represented by a second resource node connected to the code object node. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: detect a code object in a configuration code file, the code object utilized to deploy a virtual instance in a first cloud computing environment. The system may in addition generate in a security database a code object node representing the code object. The system may moreover generate in the security graph a first resource node representing the virtual instance. The system may also access a mapping between the code object and the virtual instance. The system may furthermore generate in the security graph a connection between the code object node and the first resource node based on the mapping. The system may in addition detect a cybersecurity issue on the virtual instance. The system may moreover generate an instruction to inspect a second virtual instance deployed based on the code object in a second cloud computing environment, where the second virtual instance represented by a second resource node connected to the code object node. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: detect a value of a data field in the code object; and generate the connection between the code object node and the first resource node in response to detecting the value in a corresponding data field of the first resource node. The system where the memory contains further instructions which when executed by the processing circuitry further configure the system to: generate a connection between the code object node and the second resource node in response to detecting the value in a corresponding data field of the second resource node. The system where the memory contains further instructions which when executed by the processing circuitry further configure the system to: generate an instruction to inspect the code object in response to detecting the cybersecurity issue on the virtual instance. The system where the memory contains further instructions which when executed by the processing circuitry further configure the system to: generate a cybersecurity issue node in the security database to represent the detected cybersecurity issue. The system where the first cloud computing environment is a production environment, and the second cloud computing environment is any one of: a staging environment, a testing environment, and a development environment. The system where the security database further includes a representation of the first cloud computing environment and a representation of a second cloud computing environment. The system where the memory contains further instructions which when executed by the processing circuitry further configure the system to: parse the configuration code file to detect the code object. The system where the code object includes a data field, and the data field is any one of: a resource type identifier, an application identifier, a virtual private cloud identifier, and an instance type identifier. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a monitored cloud computing environment utilizing infrastructure as code (IaC) utilized to describe the various embodiments.

FIG. 2 is a flowchart of a method for inspecting configuration code utilizing a security graph, implemented in accordance with an embodiment.

FIG. 3 is a schematic illustration of a portion of a security graph for cybersecurity risk assessment of virtual instances in a cloud computing environment, implemented in accordance with an embodiment.

FIG. 4 is a schematic illustration of a code inspector implemented according to an embodiment.

FIG. 5 is a code object, shown in accordance with an embodiment.

FIG. 6 is a schematic illustration of a unified policy engine across multiple cloud environments, implemented according to an embodiment.

FIG. 7 is a flowchart for generating an inspection instruction based on a detected code object, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Infrastructure as code (IaC) allows fast and reliable deployment of workloads and accounts in cloud-based computing environments. A workload may be, for example, a virtual machine, a container, or a serverless function. A virtual machine may be implemented for example as an Oracle® VM VirtualBox hypervisor, a container may be implemented on a Kubernetes® platform, and serverless function may be implemented as Amazon® Web Services (AWS) Lambda. Accounts may be user accounts, service accounts, roles, and the like.

A deployed cloud computing environment differs over time from the initial deployment configuration, due for example to upgrades and patches implemented in production but not updated in the code. In an embodiment, a security graph includes a representation of a cloud computing production environment, which is matched to a representation of a configuration code from which the production environment is deployed, to allow inspection of the configuration code. This allows to ascertain that code objects comply with the specification of the production environment.

In certain embodiments, multiple cloud computing environments are utilized, all of which are deployed based on the configuration code. For example, a development (dev) environment, a test environment, a staging environment, and a production environment, may all utilize the same configuration code, in an embodiment.

In some embodiments, a workload in the production environment is inspected for cybersecurity issue. A cybersecurity issue is, in an embodiment, a cybersecurity threat, such as a misconfiguration, a vulnerability, an exposure, a weak password, an exposed certificate, an exposed password, and the like. In response to detecting a cybersecurity issue on a workload, a security graph is traversed in an embodiment to detect a node corresponding to the workload. In some embodiments, the node corresponding to the workload is a node representing the workload. In other embodiments, a node corresponding to the workload represents a code object from which the workload is deployed.

In an embodiment, a node representing the workload is connected to a node representing a code object from which the workload is deployed in a cloud computing environment. In certain embodiments, the security graph is traversed to detect the node representing the code object, and an instruction is generated to inspect the code object for the cybersecurity issue detected on the workload. This is performed in order to determine that the cybersecurity issue originates from the configuration code. In an embodiment, a mitigation action is provided, for example as an instruction. The instruction, when executed, provides an alternate configuration code which does not include the detected cybersecurity issue.

In an embodiment, an alert is generated as a mitigation action, to indicate that the configuration code, when deployed, results in a production environment which is deficient, for example, due to a detected vulnerability, when compared with the current production environment.

While declaratory code is used precisely because it is intuitive for humans to read and write declaratory code, it should be appreciated that inspecting such code for cybersecurity issues is not a task that can be performed by humans. Specifically, inspecting code to detect a cybersecurity issue needs to be performed in a reliable and consistent manner, and done so repeatedly over often thousands of lines of code. Even if it were practical for a human to read through thousands of lines of computer code within any meaningful time frame (cloud computing environments are elastic and constantly changing), doing so while searching for hundreds of thousands of various cybersecurity issues is impossible. Furthermore, humans are not capable of performing such tasks repeatedly and reliably, as they apply objective standards to what is a cybersecurity issue.

Additionally, a human is not able to determine from a code object what instances are deployed across multiple cloud computing environments based on the code object. This is in part due to drifting configurations, so an instance in a first cloud computing environment may seem to a human different than a corresponding instance in a second cloud computing environment, for example due to additional patches, software applications, and the like installed on the second instance, even though in practice both instances were deployed based on the same code object.

By contrast, an embodiment of the system disclosed herein applies objective criteria in detection of cybersecurity issues, and does so in a manner which is reliable, consistent, and in a timeframe which is relevant to the operation of a cloud computing environment. Additionally, methods disclosed herein provide for improved efficiency of computer systems, by reducing use of memory, processors, and the like.

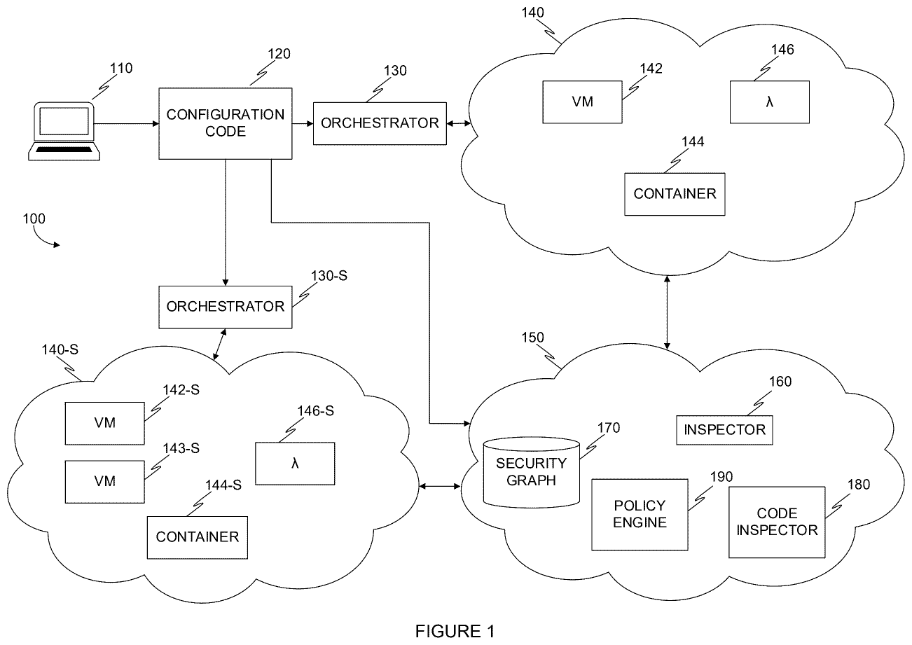

FIG. 1 is a network diagram 100 of a monitored cloud computing environment utilizing infrastructure as code (IaC) utilized to describe the various embodiments.

A client device 110 generates a configuration code file 120 based on input from one or more users (e.g., software programmers). In an embodiment, a client device is a personal computer, a tablet, a laptop, and the like. In some embodiment, a client device 110 is used to access a server (not shown) which provides a computing environment into which input can be provided. It should be apparent that the client device 110 is shown here for simplicity and pedagogical purposes, and that the configuration code file 120 is generated, in other embodiments, by the client device, a virtual workload in a cloud computing environment, a combination thereof, and the like. In certain embodiments, the configuration code file 120 is generated by multiple different client devices. For example, a plurality of users may each utilize a different client device and update a single configuration code file 120, for example, with code objects. In some embodiments, a single client device 110 generates multiple configuration code files.

In an embodiment the configuration code file 120 is implemented in a declaratory computer language. In a declaratory computer language, a user declares resources they would like to have as code objects, and an orchestrator, such as orchestrator 130, is configured to deploy workloads in a cloud computing environment based on the declarations. For example, an orchestrator 130 is configured, in an embodiment, to translate a declaratory code to a configuration code, which includes instructions which when executed configure a cloud computing environment to deploy a workload, virtual instance, and the like.

In certain embodiments, multiple configuration code files 120 may be utilized. For example, a user may operate multiple cloud environments, each with its own configuration code. For example, a first configuration code file is directed to deploying a cloud computing environment over Microsoft® Azure, while a second configuration code file is directed to deploying a cloud computing environment over Amazon® Web Services (AWS).

As another example, a user can declare a first resource type (e.g., virtual machine) for a first cloud environment (e.g., AWS) and for a second cloud environment (e.g., Google® Cloud Platform-GCP) in a first configuration code file, and a second resource type (e.g., software container) for the first cloud environment (AWS) and the second cloud environment (GCP) in a second configuration code file.

In an embodiment, an orchestrator 130 is configured to receive the configuration code file 120. In certain embodiments, the orchestrator 130 is configured to initiate actions in a cloud computing environment 140, for example, to deploy workloads, instances, user accounts, service accounts, combinations thereof, and the like, based on declarations of the configuration code file 120. In an embodiment, an instance is a virtual instance, and may be, for example a virtual machine 142, software container 144, a serverless function 146, and the like.

In some embodiments, the orchestrator 130 is configured to deploy workloads by assigning (also known as provisioning) cloud computing environment resources, such as processors, memory, storage, etc. to the workload. In an embodiment, workloads are deployed in a production environment, which is a cloud computing environment having operable code, used for providing access to data and providing software services. In some embodiments, configuration code is implemented in a development (dev) environment, which also utilizes a cloud computing environment.

In some embodiments, a plurality of workloads are associated with a first code object (not shown) of the configuration code file 120. Workloads which are all deployed based on a same code object (i.e., the first code object) are known as a virtual instance (or “instance”) of the first code object. In an embodiment, associating a workload with a code object includes assigning a name to the instance based on an identifier of the code object.

This provides an advantage where it is required to deploy multiple instances which share similar configurations, such as web servers providing access to a website. Rather than configure each instance manually and individually, an orchestrator 130 is configured to deploy a number of the same workload based on the configuration code file 120.

In some embodiments the orchestrator 130 may configure a cloud-native orchestrator (not shown) in the cloud computing environment 140 to deploy the instances. This may be advantageous, for example, where instances need to be deployed in different cloud environments.

For example, the same instances may be deployed simultaneously on Google® Cloud Platform (GCP), Amazon® Web Services (AWS), or Microsoft® Azure. This can be achieved by configuring the orchestrator 130 to generate native instructions for a cloud native orchestrator in each environment to deploy such instances. The native instructions are generated by the orchestrator 130 in an embodiment. The instructions are generated based on objects detected in the configuration code file 120.

This method of deploying instances decreases errors by eliminating the need for a user to manually deploy each instance and configure each instance separately, and is also thus a faster method of deployment. A human is not able to consistently and reliably initiate deployment of virtual instances, and then configure hundreds or thousands of such instances to match the same specification. In the example above a first load balancer may be deployed in a first cloud computing environment, and a second load balancer may be deployed in a second cloud computing environment, each cloud computing environment having different infrastructure from each other, wherein the first load balancer and the second load balancer are deployed based on the same code object from a configuration code file.

In an embodiment, the first cloud computing environment 140 is coupled with a second cloud computing environment 150, which is configured to inspect the first cloud computing environment 140 for cybersecurity threats. In an embodiment, the second cloud computing environment 150 (also referred to as inspection environment 150) is further configured to receive the configuration code file 120.

In some embodiments, the second cloud environment 150 is utilized for inspecting the first cloud computing environment 140 and generating cybersecurity risk assessments for instances deployed in the first cloud computing environment 140.

In certain embodiments, the second cloud environment 150 includes a plurality of inspectors, such as inspector 160. An inspector is a workload which is configured to inspect another workload for cybersecurity objects, such as a secret, a file, a folder, a registry value, a weak password, a certificate, a malware object, a hash, a misconfiguration, a vulnerability, an exposure, a combination thereof, and the like. In an embodiment, an inspector 180 is configured to inspect for a plurality of cybersecurity object types.

For example, in an embodiment, an inspector is configured to inspect the virtual machine 142 for a predetermined cybersecurity object, in response to receiving an instruction to inspect the virtual machine 142. In an embodiment the instruction is received through an API (not shown) of the first cloud computing environment 140. In some embodiments, an inspectable disk is generated based on a volume (not shown) attached to the virtual machine 142, and the inspectable disk is provided to the second cloud computing environment 150 for inspection. In an embodiment, generating an inspectable disk includes generating a clone of the volume, generating a copy of the volume, generating a snapshot of the volume, and the like.

In an embodiment, a software container is deployed in the second cloud computing environment 150 and attached to a volume generated in the second cloud computing environment 150 based on the received snapshot. The inspector 160 is configured, in an embodiment, to inspect the attached volume for a predefined cybersecurity object type. In an embodiment, the inspector 160 is configured to generate data which is stored on a security graph 170. In some embodiments, a node is stored on the security graph 170 to represent an inspected resource. In an embodiment, data generated by the inspector 160 is stored on the node representing the workload which the inspector 160 inspected for a cybersecurity object.

In an embodiment, the security graph 170 is stored on a graph database. The security graph 170 includes a representation of a cloud computing environment. In an embodiment, the representation includes a plurality of nodes, at least a portion of which each represent a resource or a principal. A resource is a cloud entity which provides access to a service, computer hardware (e.g., processor, memory, storage, and the like), and the like. In an embodiment, a resource is a workload, such as a virtual machine, serverless function, software container, and the like. A principal is a cloud entity which is authorized to initiate actions in a cloud computing environment, and is authorized to act on a resource. In an embodiment, a principal is a user account, a user group, a service account, and the like.

In certain embodiments, the second cloud environment 150 further includes a policy engine 190. In an embodiment the policy engine 190 is implemented as a workload, such as a virtual machine, software container, and the like. The policy engine 190 includes, in an embodiment, a rule engine having a plurality of rules. In an embodiment each rule includes a condition and an action. A rule may be implemented, for example, as an ‘if-then’ statement. In an embodiment, the policy engine 190 is configured to periodically check if one or more of the rules are violated by a workload, account, and the like, in the first cloud computing environment 140. The policy engine 190 further includes, in an embodiment, a policy which indicates a permission associated with workloads, accounts, and the like. For example, a policy states that a user account belonging to a first user group is authorized to access the VM 142. In an embodiment, the policy engine 190 is implemented in the first cloud environment 140, and accessible by the second cloud environment 150.

In some embodiments, the configuration code 120 is further utilized by a staging environment orchestrator 130-S. While this embodiment utilizes an orchestrator 130 for a production cloud environment 140, and a staging environment orchestrator 130-S for a staging cloud environment 140-S, it should be apparent that other embodiments are possible without departing from the scope of this disclosure. For example, a single orchestrator is used for both the production and staging environments, in an embodiment.

A staging environment is a cloud computing environment which is as identical as possible to the production environment. A staging environment may include test workloads, relatively small configurations drifts, and the like for testing their viability of such deviations for the production environment. Typically, workloads are deployed in a staging environment prior to deployment in a production environment, so as to detect any issues which the workload may cause in the production environment.

In an embodiment, the staging cloud environment 140-S is a cloud computing environment which is practically identical to the production cloud environment 140. In some embodiments, the staging cloud environment 140-S further includes a test workload. In an embodiment, the test workload is utilized to determine if a workload deployed in the staging cloud environment 140-S can handle a volume of expected traffic.

For example, a second VM 143-S is a workload which is deployed in the staging cloud environment 140-S, but not yet deployed in the production cloud environment 140. A first VM 142-S is a workload identical to VM 142, a software container 144-S is a workload identical to the software container 144 deployed in the production cloud environment 140, and a serverless function 146-S is identical to the serverless function 146. In an embodiment, a pair of workloads are considered identical if they are identical in everything other than an identifier, and a deployment environment.

It is common that workloads in the production environment 140 are the cause of alert generation, based for example on policies of the production cloud environment 140. In an embodiment a policy engine 190 is configured to receive an instruction to generate an exception to an error.

For example, if a VM 142 triggers an error (i.e., violates a policy), an exception is added to the policy engine 190, which results in ignoring the error when the policy is applied to the VM 142, according to an embodiment. In an embodiment, an exception is implemented as a rule, additional condition to an existing rule, and the like, in the policy engine 190.

However, as the exception is specific to the VM 142, the corresponding virtual machine of the staging environment (VM 142-S), which is identical to the VM 142, would trigger an error, based on violating the same policy. This results in generating multiple alerts for an issue which was previously resolved (i.e., by generating the exception). It is desirable to reduce the number of generated alerts as this improves user experience, for example by reducing alert fatigue. It is further desirable to reduce redundant data which requires additional storage resources.

In an embodiment, a code object of a configuration code is represented in the security graph 170 by a code object node, which is connected to a first instance node representing a first instance deployed in a production environment (e.g., production environment 140) and connected to a second instance node representing a second instance, corresponding to the first instance, deployed in a staging environment (e.g., staging environment 140-S), wherein the second instance and the first instance are both initially deployed based on the code object represented by the code object node.

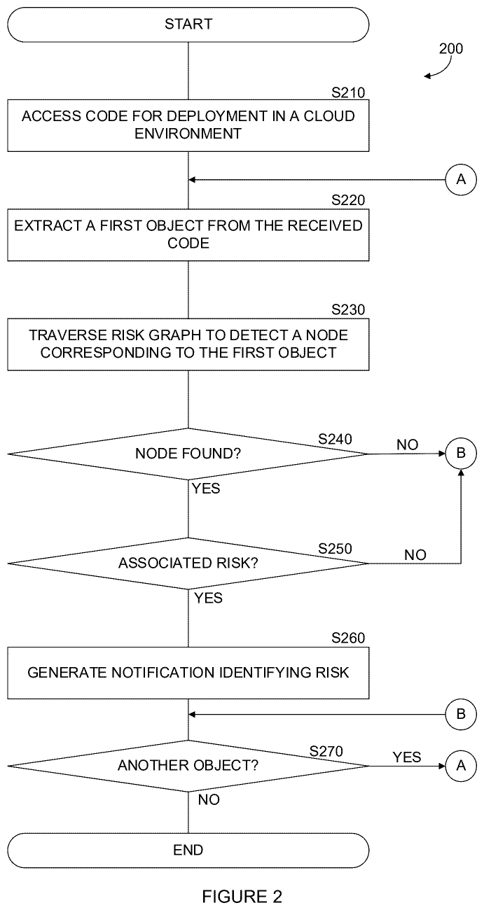

FIG. 2 is an example flowchart 200 of a method for inspecting configuration code utilizing a security graph, implemented in accordance with an embodiment. In an embodiment, configuration code in a development (dev) environment is inspected based on a security graph which is generated at least in part based on a production environment.

A production environment is rarely, if at all, identical to the environment which is deployed initially by code. This is due to, for example, upgrades and patches implemented in the production environment to address issues caused by the code deployment. Drifting configuration, or configuration drift, describes how a production environment, over time, ‘drifts’ further away from the initial configuration code design. Therefore, inspecting only one environment for cybersecurity threats is not enough, and it is advantageous to inspect both.

In an embodiment, the security graph includes representations of the configuration code (e.g., representing code objects) and the production environment (e.g., representing resources and principals). By inspecting a configuration code file based on a security graph generated from data of a production environment, insight can be gained, and deployment issues may be caught early on, for example to identify instances which if deployed based on a current version of configuration code would include a version of software which the production environment has already upgraded to a newer version. In an embodiment, the method is performed by a configuration code inspector, such as the code inspector 180.

At S210, configuration code is received. In an embodiment, the configuration code includes a plurality of code objects. In certain embodiments, a portion of the code objects correspond to instances which are deployed in a cloud computing environment. In an embodiment, the configuration code is scanned or otherwise inspected as a textual object. For example, a configuration code is searched for regular expressions (regex), strings, and the like.

At S220, a first code object is extracted from the received code. Extracting a code object includes, in an embodiment, searching the text of a configuration code file for a predetermined string. For example, a code object may be a text field identifying a type of workload, a name of a workload, a network address, a name in a namespace, a role, a permission, and the like. In some embodiments, a plurality of code objects are extracted from the received code.

At S230, a security graph is traversed to detect a node in the graph corresponding to the extracted first code object. In an embodiment, traversing the security graph includes sending a request through an API of a graph database hosting the security graph to search the graph for a string, a value, and the like, which corresponds to the first code object. For example, if the first code object includes a secret, such as a private key (i.e., an alphanumerical representation), the security graph is traversed to detect a node which represents a matching public key (e.g., public key node). In an embodiment, the public key node is connected to a resource node representing a resource which utilizes the public key.

In some embodiments, a query directed at the security graph includes a plurality of clauses. In an embodiment, multiple-clause query is generated to search for container nodes (i.e., nodes representing containers) which are connected to a node representing the public key. It is noted that detecting a node which corresponds to the extracted first object includes, in an embodiment, detecting a node which is not a node representing a workload corresponding to the first object.

For example, executing code of the first code object results, in an embodiment, in deploying a first load balancer in a virtual private cloud (VPC). In an embodiment, a node is generated in a security graph to represent the first load balancer deployed in a cloud computing environment. The node representing the load balancer is connected to a node representing the VPC.

An advantage of the disclosed method is that attributes of the first code object detected in the graph allows detecting nodes representing cybersecurity issues, nodes representing workloads, enrichment nodes, and the like, prior to the generation of an instance based on the code object. This allows detecting a security risk in an instance prior to it being deployed in a computing environment. In the above example, as the code of the first code object includes instructions to deploy in the VPC, the VPC node is detected (based, for example, on detecting an identifier of the VPC in the code) in the security graph. Cybersecurity risks represented by nodes connected to the VPC node are detected, for example by querying the security graph.

At S240, a check is performed to determine if a node is detected. If ‘no’ execution may continue at S270. In an embodiment, if a node is not detected (e.g., the node does not exist), a new node is generated in the security graph to represent the first code object. If a node is detected execution continues to S250.

At S250, a check is performed to determine if the detected node corresponds to a previously determined cybersecurity issue, such as a cybersecurity risk factor, vulnerability, misconfiguration, and the like. A risk factor, vulnerability, misconfiguration, and the like, may be, for example, access to a network resource (such as the internet), access from a network resource, outdated software, privilege escalation, and the like. In an embodiment, a risk factor score is further determined. In some embodiments, the score indicates the severity of the risk, such as ‘low’, ‘medium’, ‘high’, and ‘critical’. In an embodiment, the previously determined cybersecurity issue is detected by inspecting a disk for a cybersecurity object. In some embodiments, a detected cybersecurity issue is represented as a node in a security graph, connected to a node representing a resource on which the cybersecurity issue was detected.

In an embodiment, a mitigation instruction corresponding to the risk factor score is executed. In some embodiments, the risk factor is indicated by metadata associated with the detected node of S240. If the detected node corresponds to a previously determined cybersecurity issue execution continues at S260; otherwise, execution continues at S270.

In an embodiment, a vulnerability is represented on the security graph by a node. As an example, a node representing a workload is connected to a node representing a vulnerability. Where a workload node is the detected node, a cybersecurity vulnerability is associated with the code object.

At optional S260 a notification is generated to indicate that a security risk has been detected in the configuration code. In an embodiment the notification is sent to a client device, a user account, a combination thereof, and the like, which authored the code. Code authors are determined, in an embodiment, by a user account identifier present in the configuration code.

In some embodiments, the notification includes an indicator to specify why the notification is generated. In certain embodiments an instruction to perform a mitigation action is generated. In the example above, an alert (i.e., notification) is generated in response to detecting that a workload includes an outdated software version, and the alert includes the current software version which would need to be configured in the configuration code in order to mitigate the risk of deploying a workload with an outdated software version.

At S270 a check is performed to determine if another code object should be inspected. If ‘yes’ execution continues at S220, otherwise execution terminates.

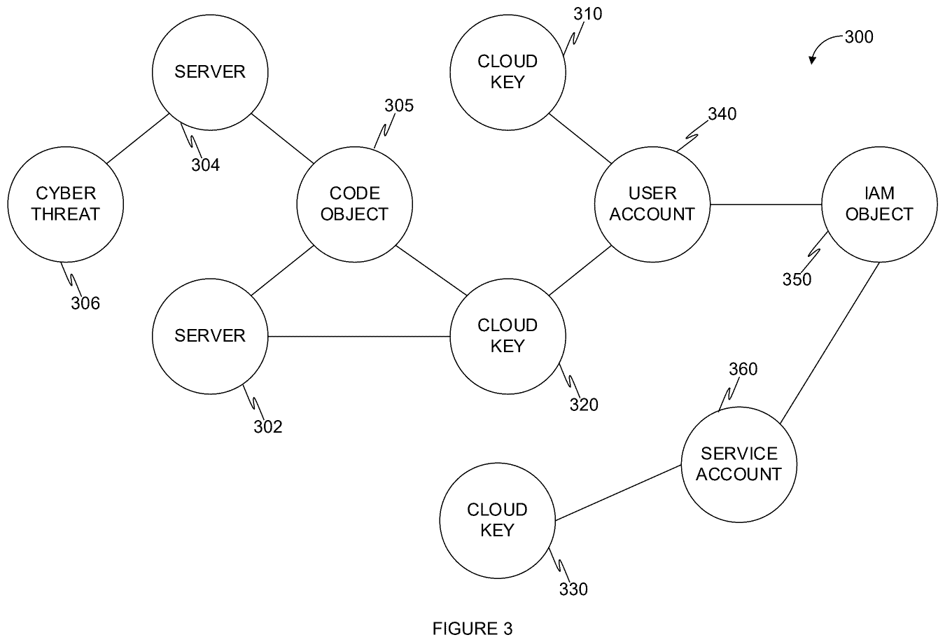

FIG. 3 is a schematic illustration of a portion of a security graph 300 for cybersecurity risk assessment of virtual instances in a cloud computing environment, implemented in accordance with an embodiment. The graph 300, which in an embodiment is stored in a graph database, includes a plurality of nodes. In an embodiment, a node represents a resource, principal, metadata, enrichment data, a cybersecurity issue, and the like.

In an embodiment, the graph 300 includes a first cloud key node 310 (representing a first cloud key) and a second cloud key node 320 (representing a second cloud key), which are connected to a user account node 340 (representing a user account). A third cloud key node 330 (representing a third cloud key) is connected to a service account node 360 (representing a service account). The user account node 340 and service account node 360 are connected to an identity and access management (IAM) object node 350 (representing an IAM object).

In an embodiment, a cloud key provides temporary access, permanent access, and the like, between a first workload and a second workload. In some embodiments, one or more first workloads and one or more second workloads may be on the same tenant, on different tenants, or on a combination thereof. In an embodiment, cloud keys are embedded into text configuration files, structured configuration files (e.g., JSON, YAML, XML, etc.), scripts, source code, and the like. Example implementations of cloud keys include AWS IAM access keys, OAuth® refresh tokens, access tokens, and the like.

By generating a security graph 300 including such nodes and populating it with data representing the cloud computing environment allows assessing of cybersecurity risks. For example, if a first cloud key is compromised, it is readily apparent what other objects are vulnerable as a result, by querying the security graph 300 and detecting cloud entities which are represented by nodes connected to, for example, a node representing the first cloud key. In an embodiment each node further stores metadata and data relating to the object. For example, a cloud key node 320 may include therein a unique account identifier.

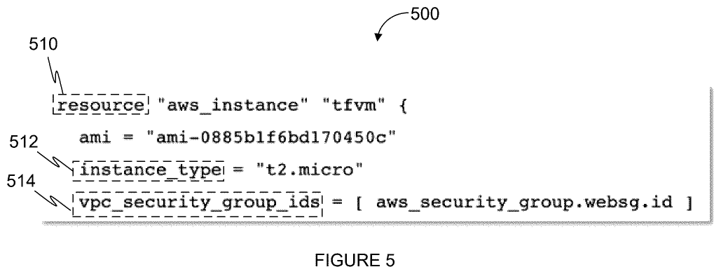

In an embodiment, a code object is represented by a code object node 305. In some embodiments, a code inspector, such as the code inspector 180 of FIG. 1, is configured to detect code objects in a configuration code, and generate an instruction, which when executed by a graph database, causes the graph database to generate the code object node 305. In an embodiment, a code object includes a plurality of data fields, such as discussed in more detail with respect to FIG. 5 below. In some embodiments, a code object node 305 includes a plurality of data fields, populated with values extracted (e.g., by a code inspector) from the configuration code.

In certain embodiments, the code inspector is configured to query the security graph 300 to detect a resource node having a data field value which matches a data field value of the code object. For example, the code object 305 includes, in an embodiment, a data field value which is shared with a first resource node 302 representing a first web server, and with a second resource node 304 representing a second web server. In an embodiment, the data field indicates that the first web server and the second web server, represented respectively by the first resource node 302 and the second resource node 304, are deployed based on the code object represented by the code object node 305.

In certain embodiments, an edge is generated between the code object node 305 and the first resource node 302, in response to determining that the resource (i.e., the server) represented by the first resource node 302 was deployed based on the code object represented by the code object node 305.

In some embodiments, the security graph 300 further includes a representation of a cybersecurity issue, such as security issue node 306. For example, a misconfiguration is represented by a node in the security graph, in an embodiment. In an embodiment the security issue node 306 representing a cybersecurity issue is connected to the first resource node 304 which represents a resource. This indicates that the resource includes the cybersecurity issue. For example, an inspector is configured to detect a cybersecurity issue, and detects the cybersecurity issue on a software container which is inspected by the inspector. In an embodiment, the security graph 300 is updated to include a node representing the software container (e.g., first resource node 302) connected to a node representing the cybersecurity issue (e.g., security issue node 306).

In some embodiments, an instruction is generated to inspect the code object represented by the code object node 305 to determine if the cybersecurity issue represented by security issue node 306 originates from the code object. In certain embodiments, an inspection instruction is generated to inspect a second resource, in response to detecting a cybersecurity issue associated with the first resource, wherein the first resource is represented by a first resource node 302, which is connected to a code object node 305, the code object node 305 further connected to a second resource node 304 representing the second resource.

In certain embodiments, generating a node representing a cybersecurity issue allows to reduce redundant information stored in a graph database, where storing a connection requires less resources than storing information about the cybersecurity issue in each node representing a resource where the cybersecurity issue is detected. This allows compact representation, thereby reducing computer resource consumption. This further allows to rapidly detect all resources having a certain cybersecurity issue, as rather than querying each node to determine if the node includes information on a specific cybersecurity issue, a single node is queried to detect nodes connected to it. This reduces the amount of processing required on a database search.

In an embodiment, a resource is represented by a resource node 302. The cloud key represented by cloud key node 310 is detected, for example by an inspector, on the resource. In an embodiment, an inspector is configured to generate an instruction which when executed by the graph database causes a connection between the cloud key node 310 and the resource node 302. In certain embodiments, the resource node 302 is a data structure which includes a plurality of data fields. A data field receives a value which represents an attribute. For example, a data field is, in an embodiment, a resource type identifier, an application identifier, a VPC identifier, an instance type identifier, and the like.

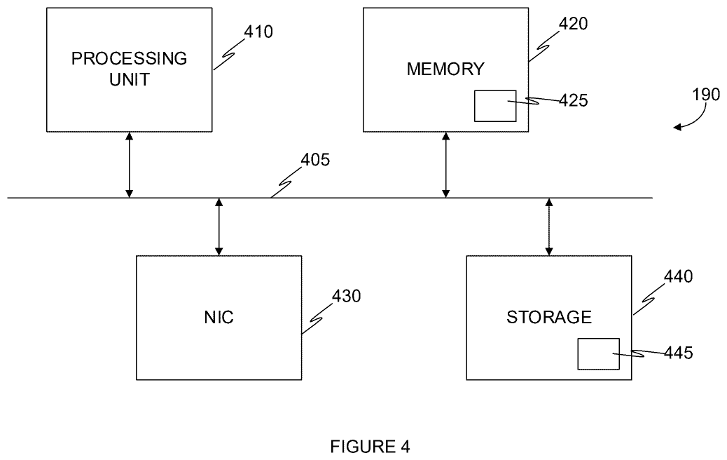

FIG. 4 is an example schematic illustration of a code inspector 180 implemented according to an embodiment. The code inspector 180 may be implemented as a physical machine or a virtual workload, such as a virtual machine or container.

When implemented as a physical machine, the code inspector 180 includes at least one processing circuitry 410, for example, a central processing unit (CPU). In an embodiment, the processing circuitry 410 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In certain embodiments it may be advantageous for the at least one processing circuitry 410 to further include one or more general purpose graphic processor units (GPGPUs). For example, for comparing and generating digests, a GPGPU may have improved performance over a CPU.

The processing circuitry 410 is coupled via a bus 405 to a memory 420. The memory 420 may include a memory portion 425 that contains instructions that when executed by the processing element 410 performs the method described in more detail herein. The memory 420 may be further used as a working scratch pad for the processing element 410, a temporary storage, and others, as the case may be. The memory 420 may be a volatile memory such as, but not limited to random access memory (RAM), or non-volatile memory (NVM), such as, but not limited to, Flash memory. The memory may further include a memory portion 425 which is used to store objects extracted from a configuration code.

The processing element 410 may be coupled to a network interface controller (NIC) 430, which provides connectivity to one or more cloud computing environments, such as the first cloud computing environment 140 of FIG. 1, via a network.

The processing element 410 may be further coupled with a storage 440. The storage 440 may be used for the purpose of holding a copy of the method executed in accordance with the disclosed technique. The storage 440 may include a storage portion 445 containing a configuration code for deployment in a cloud computing environment.

The processing element 410 and/or the memory 420 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

It should be understood that the embodiments described herein are not limited to the specific architecture illustrated in FIG. 4, and other architectures may be equally used without departing from the scope of the disclosed embodiments.

Furthermore, in certain embodiments the inspector 160, code inspector 180, policy engine 190, and security graph database 170 may be each implemented with the architecture illustrated in FIG. 4. In other embodiments, other architectures may be equally used without departing from the scope of the disclosed embodiments.

FIG. 5 is an example of a code object, shown in accordance with an embodiment. A code object 500 includes an object type 510. The object type 510 indicates, in this example, that this code object is a resource type, i.e., executing instructions related to this object will deploy a resource in a cloud computing environment. The object type further includes data fields, such as instance type data field 512 and network association data field 514. The instance type 512 specifies what type of resource is to be deployed, in this case the instance type is a t2.micro, which is a processing instance used in the AWS cloud computing environment. The network association field 514 indicates, in this example, that the instance should be associated with a specific virtual private cloud (VPC). In this example the code object is a data structure having parameters (or data fields) which can be customized to generate resources, accounts, and the like, in a cloud computing environment.

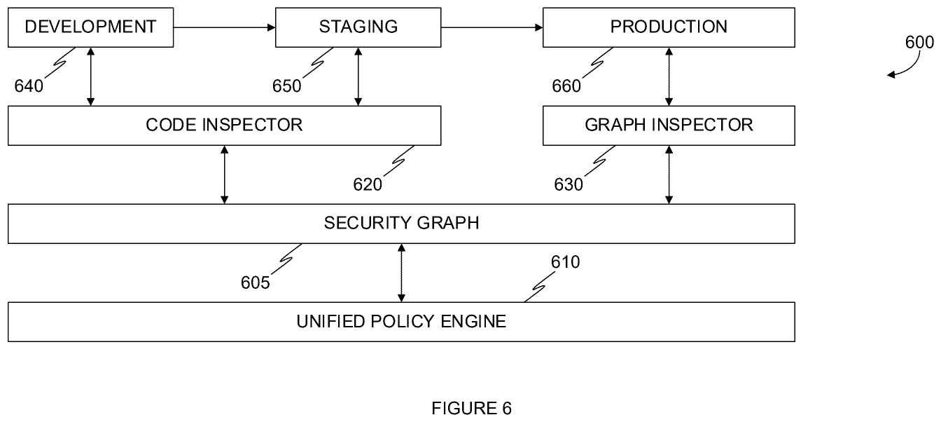

FIG. 6 is an example of a schematic illustration 600 of a unified policy engine across multiple cloud environments, implemented according to an embodiment. In some embodiments, the unified policy engine is further utilized across cloud service providers. In an embodiment, a unified policy engine 610 is a policy engine which is utilized across a full technology stack. In an embodiment, a production cycle begins in a development environment 640. The development environment 640 includes, in an embodiment, sandboxed applications, infrastructure as code (IaC) declaratory code (such as configuration code 120 of FIG. 1), and the like. For example, Microsoft® Azure offers Azure DevOps Services which may serve as a cloud based development environment.

After a workload, policy, other change, and the like, is approved in infrastructure from the development environment 640, it is implemented in a staging environment 650. For example, a workload is deployed in the staging environment 650, a policy change is updated into a policy engine of the staging environment 650, and the like. A staging environment 650 is implemented, in an embodiment, as a cloud computing environment which is identical, substantially similar, and the like, to a production environment 660 in which the workload, the change, and the like, is ultimately deployed.

The purpose of a staging environment 650 is to provide a final testing environment which simulates the production environment 660 to as high a degree as possible. This allows to eventually deploy a workload, for example, with a relatively high certainty that the workload will perform as expected. Where a workload does not perform as expected, it may be returned to the development environment 640, in order to address any problems which were detected during deployment in the staging environment 650.

A workload which passes testing of the staging environment 650 may be implemented in a production environment 660. The production environment is a cloud computing environment which is in real time use, and provides services, functionality, resources, and the like, to users, service accounts, and the like.

In an embodiment, a code object is stored as code in a configuration code file, stored in the development environment 640. The configuration code file is executed, in an embodiment, for example by Terraform®, to deploy a workload, virtual instance, user account, and the like in the staging environment 650, based on the code object.

In certain embodiments, the deployed workload is tested in the staging environment 650, for example, by executing performance tests, load tests, and the like. If the deployed workload passes the tests in the staging environment 650, the code object is added, in an embodiment, to a main configuration code file (or committed, per industry term). The next time the main configuration code file is utilized, the code object is used (e.g., to deploy instances) in the production environment 660.

In an embodiment, inspectors are utilized to inspect for cybersecurity objects which are indicative of cybersecurity issues. In some embodiments, the inspectors are utilized across different cloud computing environments. For example, in an embodiment a code inspector 620 is configured to inspect for a cybersecurity object in each of the development 640 and staging 650 environments. A cybersecurity object is, in an embodiment, an application identifier, an operating system identifier, a weak password, an exposed password, an exposed certificate, a misconfiguration, and the like.

As another example, in an embodiment a graph inspector 630 is configured to inspect for graph objects (i.e., objects which are represented in a security graph) in the production environment 660. While FIG. 6 shows inspector workloads operating in different environments, this is merely for simplicity and pedagogical purposes. In certain embodiments, a first inspector, inspecting for a first object type, is configured to inspect each cloud environment for the first object type. In other embodiments, a unique inspector for the first object type is implemented for each compute environment. In some embodiments, an inspector is configured to inspect for a cybersecurity object having a data field, attribute, or other value configured to a predetermined value.

A system administrator may make changes to a production environment policy in response to detecting a real-world event (as opposed to theoretical test cases done in staging). For example, in response to detecting a vulnerability, a system administrator may update, or create, a policy to address the vulnerability. The policy is stored in a cloud environment of the production environment 660, which is not accessible to the staging environment 650, and in some embodiments is not readable by the development environment 640. Further, there is no way for an operator of the development environment 640 or staging environment 650 to know about the policy change. Therefore, operators of the development environment 640 and staging environment 650 may continue to create workloads which violate the policies set forth in the production environment 660. This is not necessarily a design flaw, as it is advantageous to have a production and a staging environment completely isolated from each other. This ensures that changes in the staging environment do not spill over to a production environment.

By utilizing the inspector workloads across all the compute environments, and representing the detected objects in a security graph 605, a unified policy engine 610 may be utilized, which can be used to implement a policy across all the compute environments. In an embodiment, a code object is detected in the development environment 640. The code object is inspected and the content of the code object (e.g., identifier, type, etc.) is utilized to search a security graph 605 for a match. In an embodiment, a node matching the content is associated with a policy which is accessible to the unified policy engine 610.

In some embodiments, a check is performed to determine if an instance generated based on the detected code object would comply with the associated policy. For example, an instruction is generated which deploys an instance, and an associated policy is applied. In some embodiments, data from the node representing the code object is used in applying the associated policy on the data of the node representing the code object. Thus, a code object can be failed at the development environment 640 based on a policy of the production environment 660, without wasting resources and time of going through staging, for example.

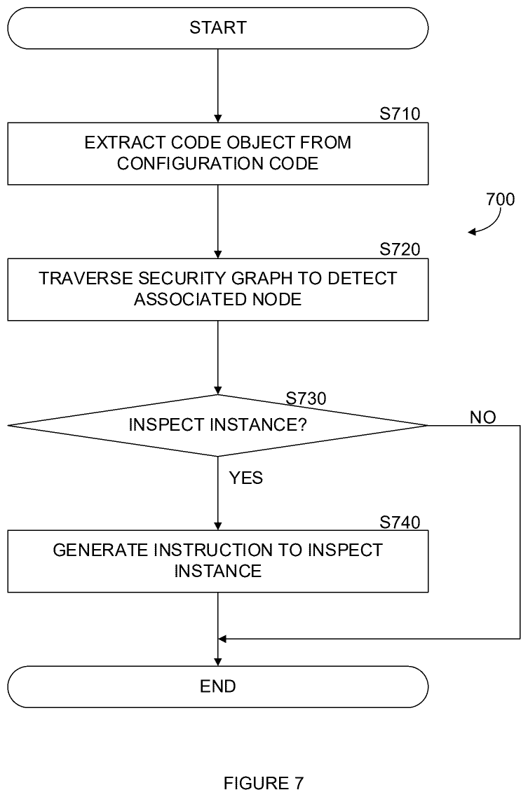

FIG. 7 is an example flowchart 700 for generating an inspection instruction based on a detected code object, implemented in accordance with an embodiment.

At S710, a code object is extracted from a configuration code file. The configuration code file includes a plurality of code objects, at least a portion of which include instructions that, when executed by an orchestrator, cause generation of principals or resources in a cloud computing environment. In an embodiment, the configuration code file 120 is implemented in a declaratory computer language. In certain embodiments, the code object includes a plurality of data fields, such as explained in more detail with respect to FIG. 5 above.

At S720, a node is detected which is associated with a code object. In an embodiment, a security graph is traversed to detect the node which is associated with the code object. For example, a security graph is queried based on values of data fields of the code object. A data field may be, for example, an identifier of an instance, an instance type, an identifier of an associated network, and the like. In an embodiment, a node is associated with a code object if, for example, a value of a data field of the node and a value of the data field of the code object match.

In the example of FIG. 5 above the code object may be matched to a node in the security graph which represents a VPC. In an embodiment, a code object matches a node, if for example a workload, virtual instance, and the like, is generated based on the code object represented by the node.

In certain embodiments, an orchestrator generates a state file, which includes a mapping between a code object in a configuration code file, and an identifier of an instance deployed in a cloud computing environment. In some embodiments, a state file is accessed to detect the mapping, and the mapping is represented in a security graph by connecting a node representing a code object to a node representing a deployed instance.

At S730, a check is performed to determine if the instance which is represented by the detected node should be inspected. If ‘yes’ execution continues at S740. If ‘no’ execution may terminate, or in another embodiments continue at S720 with another node. In yet another embodiment, if the check returns ‘no’ execution may continue at S710 with another code object. Inspection of an instance is initiated, in an embodiment, in response to determining that inspection of an instance in a first cloud computing environment (e.g., production environment) detected a cybersecurity issue. The instance is represented in a security graph by a node which is connected to a node representing a code object from which the instance was deployed. The node representing the code object is further connected to another node representing another instance, deployed in a second cloud computing environment. In an embodiment, the security graph is traversed to detect another node, and inspection of the instance represented by the another node is initiated.

At S740, an instruction to initiate an inspection of a workload corresponding to the node is generated. Inspecting the workload includes, in an embodiment, generating an inspectable disk of the workload, for example, by generating a disk clone, and providing access to the cloned disk through an inspection service account to an inspector (such as inspector 160 of FIG. 1). In an embodiment, a volume may be mounted based on the cloned disk, which the inspector 160 may access to inspect for at least a data object. In some embodiments, the cloned disk is released (i.e., resources are deallocated) in response to receiving an indication from an inspector that inspection of the cloned disk is complete.

Generating inspection instructions based on code objects is advantageous as it reduces the requirement to inspect a network environment for virtual workloads. Instead, new workloads may be discovered by inspecting the code which generates them, while security issues in workloads in a production environment may in turn be traced back to code objects from which they are generated.

In other embodiments, an inspection instruction is generated for a first instance deployed in a first cloud computing environment, in response to detecting that a corresponding second instance deployed in a second cloud computing environment includes a cybersecurity issue, wherein the first instance and the second instance are deployed based on a single code object. In some embodiments, the inspection instruction is generated in response to detecting that a first resource node representing the first instance is connected to a code object node representing the code object, and the code object node is further connected to a second resource node representing the second instance. In some embodiments the second resource node is connected to a cybersecurity issue node, representing a cybersecurity issue.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for inspecting multiple instances across cloud computing environments for a cybersecurity issue, comprising:
detecting a code object in a configuration code file, the code object utilized to deploy a virtual instance in a first cloud computing environment;
generating in a security database a code object node representing the code object;
generating in the security graph a first resource node representing the virtual instance;
accessing a mapping between the code object and the virtual instance;
generating in the security graph a connection between the code object node and the first resource node based on the mapping;
detecting a cybersecurity issue on the virtual instance; and
generating an instruction to inspect a second virtual instance deployed based on the code object in a second cloud computing environment, wherein the second virtual instance represented by a second resource node connected to the code object node.

2. The method of claim 1, further comprising:
detecting a value of a data field in the code object; and
generating the connection between the code object node and the first resource node in response to detecting the value in a corresponding data field of the first resource node.

3. The method of claim 2, further comprising:
generating a connection between the code object node and the second resource node in response to detecting the value in a corresponding data field of the second resource node.

4. The method of claim 1, further comprising:
generating an instruction to inspect the code object in response to detecting the cybersecurity issue on the virtual instance.

5. The method of claim 1, further comprising:
generating a cybersecurity issue node in the security database to represent the detected cybersecurity issue.

6. The method of claim 1, wherein the first cloud computing environment is a production environment, and the second cloud computing environment is any one of: a staging environment, a testing environment, and a development environment.

7. The method of claim 1, wherein the security database further includes a representation of the first cloud computing environment and a representation of a second cloud computing environment.

8. The method of claim 1, further comprising:
parsing the configuration code file to detect the code object.

9. The method of claim 1, wherein the code object includes a data field, and the data field is any one of: a resource type identifier, an application identifier, a virtual private cloud identifier, and an instance type identifier.

10. A non-transitory computer-readable medium storing a set of instructions for inspecting multiple instances across cloud computing environments for a cybersecurity issue, the set of instructions comprising:
one or more instructions that, when executed by one or more processing circuitries of a device, cause the device to:
detect a code object in a configuration code file, the code object utilized to deploy a virtual instance in a first cloud computing environment;
generate in a security database a code object node representing the code object;
generate in the security graph a first resource node representing the virtual instance;
access a mapping between the code object and the virtual instance;
generate in the security graph a connection between the code object node and the first resource node based on the mapping;
detect a cybersecurity issue on the virtual instance; and
generate an instruction to inspect a second virtual instance deployed based on the code object in a second cloud computing environment, wherein the second virtual instance represented by a second resource node connected to the code object node.

11. A system for inspecting multiple instances across cloud computing environments for a cybersecurity issue comprising:
a processing circuitry;
a memory, the memory containing instructions that, when executed by the processing circuitry, configure the system to:
detect a code object in a configuration code file, the code object utilized to deploy a virtual instance in a first cloud computing environment;
generate in a security database a code object node representing the code object;
generate in the security graph a first resource node representing the virtual instance;
access a mapping between the code object and the virtual instance;
generate in the security graph a connection between the code object node and the first resource node based on the mapping;
detect a cybersecurity issue on the virtual instance; and
generate an instruction to inspect a second virtual instance deployed based on the code object in a second cloud computing environment, wherein the second virtual instance represented by a second resource node connected to the code object node.

12. The system of claim 11, wherein the memory contains further instructions which when executed by the processing circuitry further configure the system to:
detect a value of a data field in the code object; and
generate the connection between the code object node and the first resource node in response to detecting the value in a corresponding data field of the first resource node.

13. The system of claim 12, wherein the memory contains further instructions which when executed by the processing circuitry further configure the system to:
generate a connection between the code object node and the second resource node in response to detecting the value in a corresponding data field of the second resource node.

14. The system of claim 11, wherein the memory contains further instructions which when executed by the processing circuitry further configure the system to:
generate an instruction to inspect the code object in response to detecting the cybersecurity issue on the virtual instance.

15. The system of claim 11, wherein the memory contains further instructions which when executed by the processing circuitry further configure the system to:
generate a cybersecurity issue node in the security database to represent the detected cybersecurity issue.

16. The system of claim 11, wherein the first cloud computing environment is a production environment, and the second cloud computing environment is any one of: a staging environment, a testing environment, and a development environment.

17. The system of claim 11, wherein the security database further includes a representation of the first cloud computing environment and a representation of a second cloud computing environment.

18. The system of claim 11, wherein the memory contains further instructions which when executed by the processing circuitry further configure the system to:
parse the configuration code file to detect the code object.

19. The system of claim 11, wherein the code object includes a data field, and the data field is any one of: a resource type identifier, an application identifier, a virtual private cloud identifier, and an instance type identifier.
